(19) United States
(12) Patent Application Publication
(10) Pub. No.: US 2024/0143995 A1
(43) Pub. Date: May 2, 2024

(54) DETERMINING A DISTRIBUTION FOR A NEURAL NETWORK ARCHITECTURE

(71) Applicant: GM Cruise Holdings LLC, San Francisco, CA (US)

(72) Inventor: Burkay Donderici, Burlingame, CA (US)

(21) Appl. No.: 17/977,889

(22) Filed: Oct. 31, 2022

(51) Int. Cl. G06N 3/08

(52) U.S. Cl. CPC G06N 3/08

(57) ABSTRACT

Systems and techniques are provided for determining a distribution for a neural network parameter in designing a neural network architecture of an autonomous vehicle (AV). An example method can include determining an exploration distribution of a neural network parameter for one or more neural networks of one or more AVs; determining, for a target context, a target distribution of the neural network parameter from the exploration distribution, the target context comprising at least one of a driving environment associated with a location, a hardware configuration of one or more AVs, a software configuration of the one or more AVs, and a task of the one or more AVs; and providing, to a computer of an AV, the target distribution for implementing one or more neural network parameter values in the target distribution to adjust a neural network of the computer of the AV for operation in the target context.

### BACKGROUND

### 1. Technical Field

The present disclosure generally relates to determining a distribution for a neural network architecture implemented by a software of an autonomous vehicle and, more specifically, determining a distribution for neural network parameters in designing a deep learning architecture for a new environment implemented by a software of an autonomous vehicle.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some examples of the present disclosure;

FIG. 2 illustrates an example system for designing and/or adapting a deep learning algorithm or model of an AV to a particular context, according to some examples of the present disclosure;

FIG. 3 is a diagram illustrating an example exploration distribution generated for one or more neural networks implemented by one or more AVs, according to some examples of the present disclosure;

FIG. 4 is a diagram illustrating an example target distribution generated and/or selected for a particular AV context, according to some examples of the present disclosure;

FIG. 5 is a diagram illustrating example target distributions generated from an exploration distribution, according to some examples of the present disclosure;

FIG. 6 is a flowchart illustrating an example process for determining a target distribution of tunable parameters for a given AV context, according to some examples of the present disclosure;

FIG. 7 is a flowchart illustrating an example process for determining a distribution of tunable parameters for a particular AV context, according to some examples of the present disclosure;

FIG. 8 illustrates an example of a deep learning neural network that can be designed based on a distribution of neural network parameters, according to some examples of the present disclosure; and

FIG. 9 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs) include various hardware components (including mechanical and electrical/electronics components) and software components that enable autonomous driving. More specifically, AVs utilize hardware components (e.g., sensors) to measure and collect data about a driving environment around the AVs, and utilize software features (e.g., AV driving compute platform, control algorithms for machine learning, prediction, and path planning, etc.) to analyze the data from those hardware components. For example, as previously explained, AVs can include various sensors, such as a camera, a light detection and ranging (LIDAR) sensor, a radio detection and ranging (RADAR) sensor, an inertial measurement unit (IMU), a time-of-flight (TOF) sensor, amongst others, which the AVs can use to collect data and measurements. The sensors can provide the data and measurements to an internal computing system of the AV (e.g., which can implement an AV software stack including, for example, a perception stack, a control stack, a prediction stack, a planning stack, etc.). The AV can use the sensor data for operations of the AV such as navigation.

The internal computing system of the AV can include one or more machine learning models (e.g., neural networks) that can be used for autonomous operations of the AV. For example, sensor data can be provided, as input, to a machine learning algorithm/model, which then generates an output used for one or more operations/functions performed by the AV. For a given architecture of a neural network, the values of neural network parameters can determine how accurately the machine learning model can perform the task (e.g., objection detection for a perception model, predicting a trajectory of objects for a prediction model, planning a route/path of an AV for a planning model, etc.). Examples of machine learning models can include, without limitation, deep learning models, support vector machine models, linear regression models, and/or decision tree models.

A machine learning model can include “trainable neural network parameters” (e.g., values or weights). As used herein, trainable neural network parameters of a machine learning model can refer to neural network parameters that can be chosen/learned and/or adjusted by the machine learning model itself. For example, trainable neural network parameters can include parameters that can be learned by the machine learning model through training. To illustrate, the trainable neural network parameters can include parameters that the machine learning model can learn and adjust through training of the machine learning model using a training dataset. In some examples, when training a machine learning model, a loss function can be used to learn/adjust trainable neural network parameters. Moreover, through the training of the machine learning model, the loss function can be optimized, for example, using gradient descent. Non-limiting examples of trainable neural network parameters can include biases and weights, values, among others.

A machine learning model can also include additional parameters that are separate/different from the trainable neural network parameters such as “tunable parameters” as referred to herein. Tunable parameters can include parameters that cannot be (or cannot feasibly be) learned/chosen by the machine learning model itself and/or directly trained from data, and/or parameters that need to be explored for a range of possibilities. As an example, tunable parameters can define the network structure or architecture of the machine learning model (e.g., number of layers or depth of layers), how the machine learning model is trained (e.g., learning rate), etc. Non-limiting examples of tunable parameters include a number of neural network layers, a depth of neural network layers, neural network functions (e.g., activation functions, loss functions, etc.), learning rates (e.g., step sizes), filter counts, padding, input size, output size, stride, a number of clusters to use, a grid cell size used in processing, a number of cells used in processing, thresholds used to determine detections, other hyperparameters, and/or any other parameters that are not learned/chosen by the machine learning model and instead are set by the user (e.g., the programmer/developer).

AVs are generally designed to operate optimally (e.g., within a threshold safety metric or range of safety metrics, within a threshold performance or range of performances, etc.) in a driving environment that the AVs navigate with the hardware and software configurations that are implemented by the AVs. As an AV navigates and collects more data (e.g., sensor data, statistics, etc.), neural network parameters (e.g., trainable parameters and/or tunable parameters) may need to be adjusted to conform to the newly collected data so that the machine learning model can accurately perform its task(s) based on the updated data. If an AV needs to perform a new task and/or operate in a new location, with a new hardware, and/or with a new/modified software configuration, certain neural network parameters may need to be adjusted to improve the safety and/or performance of the AV. As follows, a model architecture can be determined by tuning/optimizing the neural network parameters including tunable parameters. Since tunable parameters cannot be learned/chosen by the machine learning model and/or are not feasibly trained/learned directly from data, it may be desirable to keep the training and validation dataset fixed. In other words, it may be helpful and efficient to have a fixed search space (e.g., a distribution) for searching the optimal neural network parameters.

The systems, apparatuses, processes (also referred to as methods), and computer-readable media (collectively referred to as “systems and techniques”) described herein can determine a distribution for neural network parameters, including tunable parameters that cannot be directly trained or learned by a machine learning model from the data or that cannot be feasibly trained/learned, so that software components of an AV can be adjusted to a new environment/location, hardware configuration, software configuration, task, and/or operating criteria. For example, the systems and techniques can determine a distribution for optimizing neural network parameters of an AV so that software components of an AV implementing one or more machine learning models can be adjusted to a new driving context that may involve a new driving environment (e.g., location) and/or new AV characteristics (e.g., hardware configurations, software configurations, and/or tasks), and/or to improve a performance of an AV (e.g., a performance of one or more machine learning models implemented by an AV) in a particular context (e.g., a particular environment, a particular hardware configuration of the AV, a particular software configuration of the AV, a particular task of the AV, etc.).

To illustrate, as previously explained, AVs are often designed to operate optimally in a particular, target environment and given certain AV hardware and/or software configurations and AV tasks. When the AV needs to operate in a new/different city, with new/different hardware, or is given new/different tasks, and/or when the AV collects more data, the software of the AV can be adjusted to perform better and/or be better suited for the new/different city, the new/different hardware and/or software, the new/different task, and/or the scene elements described or depicted in the additional data collected by the AV. In some aspects, the systems and techniques described herein can design AV components using a defined set of tunable parameters and a distribution of parameters (e.g., a distribution of parameter values), and can delegate the realization of software to an optimization algorithm that finds the optimum in a search space (e.g., the distribution of parameter values). This can allow for automated re-adjustment of the AV (e.g., the AV software) to different environments, different hardware configurations, and/or different contexts.

Moreover, different distributions of parameters and parameter values can be applied for different adaptation goals. For example, to adapt a software of an AV to new scene data, a narrower distribution of parameters/parameter values can be used since the new scene data may not be expected to be very different from current scene data. On the other hand, the AV may use a broader/wider distribution of parameters/parameter values to adapt the software of the AV to a new/different city and/or a new/different hardware. In some cases, the distribution of parameters/parameter values can be determined from historical data (e.g., data collected via one or more sensors of one or more AVs) on new/different data from new/different use cases, such as edge cases, new/different environments, new/different hardware, etc., by calculating one or more optimums in such different conditions and fitting a distribution to the results.

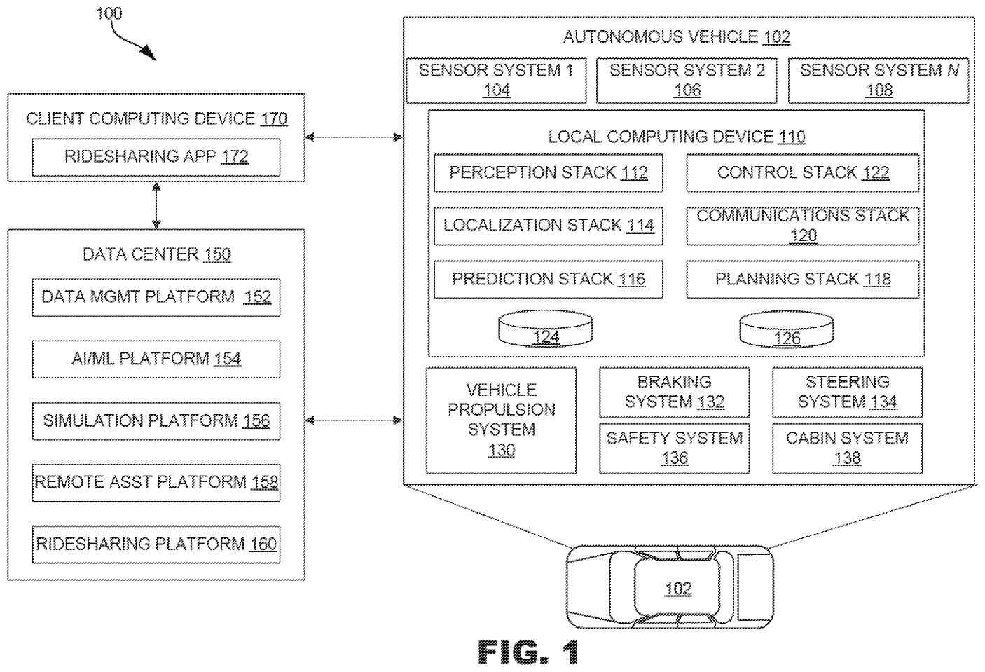

Examples of the systems and techniques described herein are illustrated in FIG. 1 through FIG. 9 and described below.

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUS, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. The client computing device 170 can be a customer's mobile computing device or a computing device integrated with the AV 102 (e.g., the local computing device 110). The ridesharing platform 1160 can receive requests to pick up or drop off from the ridesharing application 1172 and dispatch the AV 1102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit (en route) to a pick-up or drop-off location, and so on.

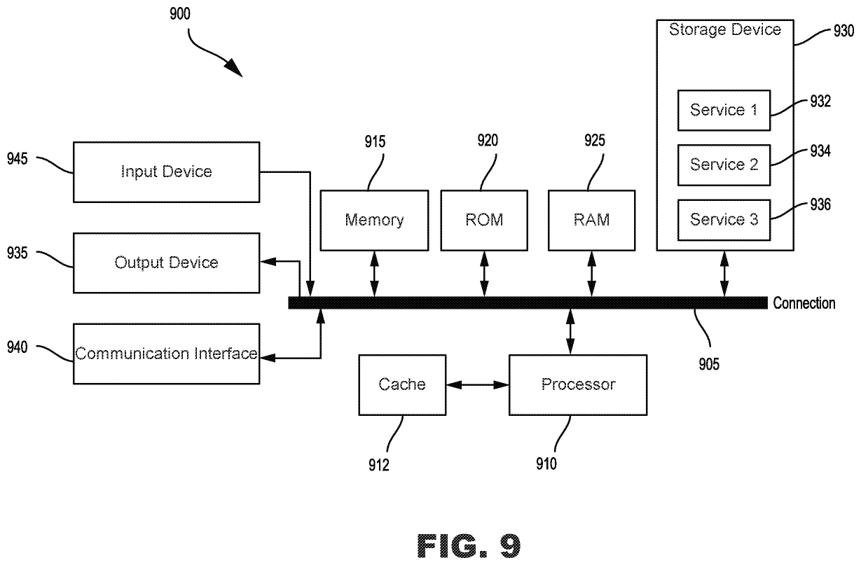

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 9.

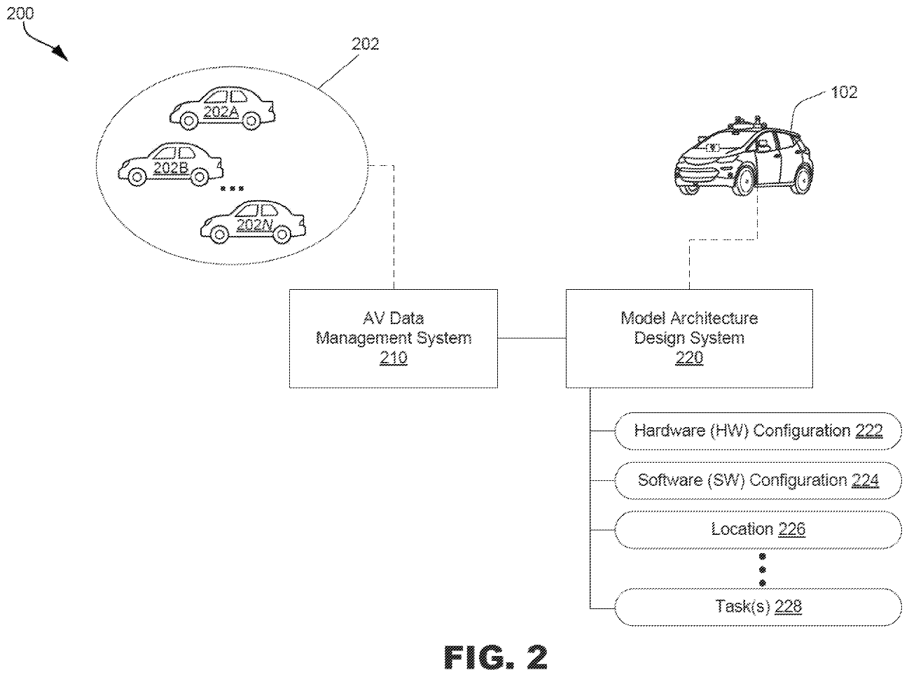

FIG. 2 illustrates an example system 200 for implementing tunable machine learning (ML) architecture for different contexts associated with a vehicle, such as an autonomous vehicle (e.g., AV 102). In some examples, the system 200 can allow the ML algorithm and/or model (e.g., a neural network model) to adapt to different AV data and/or contexts (e.g., environments, hardware configurations, AV configurations, software configurations, conditions, tasks, etc.). In some cases, the example system 200 can be used to intelligently determine and/or tune the search space for parameters and parameter values for an ML algorithm and/or model, such as a neural network model. In other words, the example system 200 can additionally or alternatively be used to design and/or tune a neural network architecture/model that can adapt to new/different AV data and/or contexts. In some examples, an AV data management system 210 can receive AV context data associated with a context. The AV context data can provide a context of an AV including an environment associated with the AV (e.g., a physical scene and/or location of the AV), a hardware configuration, a software configuration of the AV, one or more tasks implemented by the AV, and/or a combination thereof. In some examples, the AV context data can include AV sensor data. More specifically, the AV data management system 210 can collect AV sensor data captured by one or more sensors (e.g., sensor system 104, sensor system 106, sensor system 108 as illustrated in FIG. 1) of one or more AVs, such as AV 202A, AV 202B, and/or AV 202N, collectively referred to herein as “AVs 202”. The sensor data from each of the AVs 202 can be collected while each AV is navigating in a particular context, which can include a driving environment (e.g., a real-world or virtual location and/or scene). In some examples, a context can additionally include one or more AV characteristics (e.g., a hardware configuration of the AV, a software configuration of the AV, a task(s) of the AV, etc.). The sensor data from the AVs 202 can correspond to (e.g., can describe and/or can be collected in and/or during) one or more of (or one or more combinations of) a number of possible locations associated with the AVs 202, environments associated with the AVs 202, hardware configurations of the AVs 202, software configurations of the AVs 202, and/or tasks associated with the AVs 202. For example, the sensor data can be collected by the AVs 202 from a number of possible locations and/or environments, while the AVs 202 implement/perform certain hardware and/or software configurations, and/or while the AVs 202 implement/perform one or more tasks.

Alternatively, the AV data management system 210 can receive AV context data including input from a user (e.g., a developer or a programmer) specifying the context of the AV and/or input from another device or algorithm that describes or identifies the context of the AV. In other examples, the AV data management system 210 can receive AV context data based on a detected event such as an upgrade of hardware and/or software components, installation of hardware and/or software components, repair or replacement of hardware and/or software components, which can trigger the AV data management system 210 to know of a new/different context of the AV.

A particular context of an AV can include and/or can be defined by, for example and without limitation, a hardware configuration of the AV, a software configuration of the AV, a geographic location of the AV, a task(s) of the AV, an operating criteria/parameter of the AV, and/or other circumstances associated with an AV. In some examples, a particular context is associated with a geographic location such as a county, a city, a district, a zip code, a state, a neighborhood, a zone, etc., that each of the AVs 202 is navigating. For example, sensor data from AV 202A can be collected by one or more sensors of the AV 202A while the AV 202A navigates in the city of San Francisco, sensor data from one or more sensors of the AV 202B can be collected while the AV 202B navigates in the city of Houston, and sensor data from one or more sensors of the AV 202N can be collected while the AV 202N navigates in a particular neighborhood in the state of Texas. Moreover, contexts can be based on a human-defined classification(s) such as a zip code or state, or can be based on algorithmically determined classifications such as classification obtained via clustering.

In some cases, a particular context of an AV is associated with a respective hardware configuration of the AV. For example, a context of an AV can include or can be defined by the hardware configuration of the AV, among other things. The hardware configuration of an AV can include the specific hardware devices/components implemented by the AV and/or can be related to any design or operational characteristics/features of hardware components of the AV such as, for example, and without limitation, one or more sensors (e.g., a camera sensor, a LiDAR sensor, a RADAR sensor, an IMU, a TOF sensor, etc.), one or more mechanical systems of the AV (e.g., vehicle propulsion system 130, braking system 132, steering system 134, safety system 136, cabin system 138 as illustrated in FIG. 1), one or more electrical systems of the AV (e.g., a battery system, one or more circuits, one or more computer systems, etc.), and/or any other hardware systems/components. Non-limiting illustrative examples of hardware configurations of an AV can include a type(s) of sensor(s) implemented by (e.g., mounted on, integrated in, used by, etc.) the AV, a number of sensors implemented by the AV, a location/position of the sensors implemented by the AV (e.g., which can impact the field-of-view or field-of-coverage of the sensors, among other things), a placement and/or position (e.g., angle, azimuth, orientation, elevation, etc.) of the sensors, a geometry and/or arrangement of the sensors with respect to each other and/or the AV, a combination of different types of sensors, a resolution of the sensors, a scanning pattern of one or more of the sensors, a frame rate of one or more of the sensors, a firmware version of the sensors, a frequency of one or more of the sensors, an exposure of one or more camera devices implementing one or more camera sensors, an operating temperature of the sensors, a power mode of the sensors (e.g., a power/energy saving mode), a higher power mode (and thus higher operating parameters such as resolution, framerate, an off mode, and/or any other mode), one or more settings of one or more hardware components of the AV, one or more specific mechanical systems and/or types of mechanical systems of the AV, one or more electrical systems and/or types of electrical systems of the AV, one or more hardware components and/or types of hardware components implemented by the AV, and/or one or more hardware capabilities and/or hardware limitations associated with the AV, among other hardware details.

In some examples, a particular context of an AV can be associated with (e.g., can be defined by) the software configuration of the AV. The software configuration of the AV can include, for example and without limitation, one or more software components of the AV (e.g., an AV compute platform, one or more control algorithms, one or more machine learning models, one or more AV software stacks (e.g., a perception stack, a control stack, a prediction stack, a planning stack, a path planning stack, etc.), an operating system (OS) and/or OS version implemented by a computer system (e.g., an autonomous driving computer system (ADCS) of the AV (e.g., a robot operating system or ROS), a version of one or more software modules and/or stacks of the AV, a software version of the AV, a configuration of one or more software components of the AV, one or more software algorithms or modules of the AV, and/or other software details. The software configuration may comprise a processing range, a number of clusters used in the algorithm, a resolution of a grid used in the algorithm, a bandwidth of a filter used in the pre-processing of data, a number of objects processed, a number of paths processed, and/or a maximum allowable reaction time before a safe stop (e.g., a stop having at least a threshold safety metric) occurs.

In some cases, a particular context can be associated with a task(s) that each of the AVs 202 is performing at a given time. For example, a particular context of the AV 202A can include a task performed (or being performed) by the AV 202A such as carrying passengers, a particular context of the AV 202B can include a task performed (or being performed) by the AV 202B such as transporting goods, and a particular context of the AV 202N can include a task performed (or being performed) by the AV 202N such as a particular AV maneuver (e.g., braking, turning, accelerating, parking, changing lanes, entering or exiting a roadway, etc.).

In some cases, each of the AVs 202 can have a different context including respective driving environments (e.g., locations and/or scenes), tasks, and/or AV characteristics (e.g., hardware configurations, software configurations, etc.). In other words, each of the AVs 202 can have a distinct context, which can include a respective (or a combination of) location, hardware configuration, software configuration, and/or task. For example, AV 202A can collect sensor data in a particular context such as while the AV 202A is carrying passengers in San Francisco, AV 202B can collect sensor data in a particular context such as while the AV 202B is carrying goods in Houston, and AV 202N can collect sensor data in a particular context such as when the AV 202N is implementing a particular hardware/software configuration(s) while the AV 202N is executing a task in a particular scene/location. Other example contexts of AV 202A can include the AV 202A implementing n number of LiDAR sensors mounted on the AV 202A, and another example context of AV 202B can include the AV 202B having n number of different types of sensors (e.g., camera sensor, LIDAR, RADAR, IMU, time-of-flight sensor, etc.) mounted on the AV 202B.

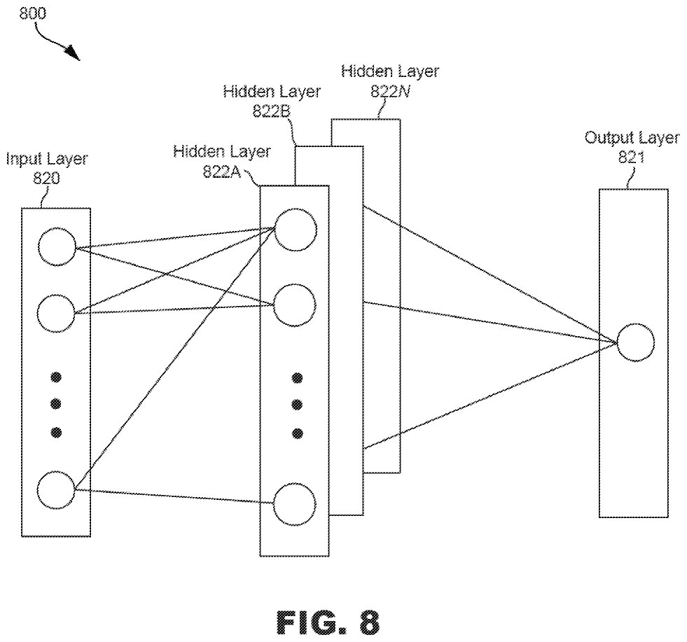

Furthermore, the software components of each of the AVs 202 can include tunable parameters that are associated with a respective neural network of each of the AVs 202 (similar to neural network 800 as illustrated in FIG. 8). As noted, tunable parameters (e.g., tunable neural network parameters) cannot be (or cannot feasibly be) directly learned from data by the neural network or chosen by the neural network through training of the neural network with training data. Non-limiting illustrative examples of tunable parameters of a neural network can include a number of neural network layers, a layer width (e.g., a number of neurons in a layer) of each layer of the neural network, a kernel size, a number of layers in a block of a neural network, a number of hidden layers (e.g., hidden layers 822A, 822B, through 822N as illustrated in FIG. 8) of the neural network, functions (e.g., number and/or type) implemented by the neural network, a type and/or number of activation functions implemented by the neural network, a learning rate of the neural network, a number of clusters used/to use, the grid cell size used in processing, a number of cells used in processing, thresholds used to determine detections, etc. Further discussion of a neural network is provided below with respect to FIG. 8.

The AV data management system 210 can collect various types of data associated with the AVs 202 such as sensor data captured by the AVs 202 while navigating/driving, environment data (e.g., a location, scene features, weather details, traffic details, visibility conditions, etc.) associated with the AVs 202, AV profile data relating to AV characteristics/features (e.g., hardware configuration, software configuration, AV task, etc.), and/or neural network data (e.g., values of tunable parameters that are implemented on the AVs 202, features of a neural network architecture) associated with AV stacks of the AVs 202. In some examples, some data can be embedded in another type of data as metadata. For example, location information and/or timestamps can be embedded in sensor data. In some examples, the locations of the AVs 202 can be determined/inferred based on sensor data.

The model architecture design system 220 can include one or more algorithms configured to determine a neural network architecture of a neural network model and/or one or more parameters (and associated parameter values) of the neural network model, such as one or more tunable neural network parameters (and associated parameter values) as further discussed herein. In some examples, the model architecture design system 220 can communicate with the AV data management system 210 to receive various types of data (e.g., image data, scene data, inertial measurements, location information, timestamps, depth measurements, motion measurements, other sensor data, statistics, etc.) associated with the AVs 202. Based on such data, the model architecture design system 220 can determine a distribution(s) of tunable parameters of neural networks of the AVs. A distribution of tunable parameters can define a range of neural network parameter values (for example, a kernel size parameter can be in a range of 2 to 4). The distribution of tunable parameters can define a set of neural network parameter values (for example, kernel size is in the set [2, 3, 4]; in other words, a distribution of a kernel size includes tunable parameter values such as 2, 3, and 4). In some examples, the distribution of tunable parameters can define a distribution of neural network parameter values and associated weights or biases (for example, a distribution can indicate that a kernel size is in the set [2, 3, 4] and is associated with the respective weights [1, 8, 3], where the weight value of 1 in the set of weights corresponds to the kernel size value of 2 in the set of kernel sizes, the weight value of 8 in the set of weights corresponds to the kernel size value of 3 in the set of kernel sizes, and the weight value of 3 in the set of weights corresponds to the kernel size value of 4 in the set of kernel sizes).

The magnitude of a distribution can indicate the relative importance of a corresponding value in the distribution. To illustrate using the example above, the kernel size value of 2 in the set of kernel size values can have an importance defined or attributed by a weight of 1 from the set of weights, the kernel size value of 3 can have an importance defined or attributed by a weight of 8 from the set of weights, and the kernel size value of 4 can have an importance defined or attributed by a weight of 3 from the set of weights. The weights can be used when conducting a search within the distribution (e.g., when searching a parameter value(s) within the distribution) to determine how much time, resources, and/or compute to spend on searching and/or assessing each value (e.g., each tunable parameter value) within the distribution. For example, when using a stochastic search algorithm, the weights associated with certain parameter values can determine the relative probability of using one parameter value with respect to another parameter value(s) in the distribution.

As noted above, the model architecture design system 220 can assign a weight to each of the values in a set of values associated with a distribution. In some examples, the model architecture design system 220 can assign a weight to each value in a set based on the likelihood of appearance or usage of that value. In other words, acceptable/allowable values of neural network parameters in a distribution can have a weight based on the importance or probability (e.g., probability of use and/or probability of the value having a certain/desired effect) of each value. For example, assume that an exploration distribution for a number of layers includes the set of values [8, 16, 32, 64, 120]. For each value 8, 16, 32, 64 and 120, a weight can be given based on its importance and/or based on a probability or likelihood of being selected as an optimal value. If the value 16 is the most important value or the most likely value to be selected as an optimal value, a higher weight such as 0.8 (e.g., meaning 80%) can be assigned to that value. If the value 32 has a lower importance or lower probability of being selected as the optimal value, a lower weight such as 0.02 (e.g., meaning 2%) can be assigned to that value.

In some cases, the model architecture design system 220 can generate an exploration distribution. The exploration distribution can include, for example, and without limitation, a group of values (e.g., an entire group of values, etc.) of the HW configuration 222, SW configuration 224, location 226, and/or task 228, that are used by the model architecture design system 220 and implemented in the AV stacks of the AVs 202. For example, if a number of layers of a neural network of the AV 202A is 2, a number of layers of a neural network of the AV 202B is 4, and a number of layers of a neural network of the AV 202N is 6, an exploration distribution of the number of layers associated with the neural network can include values 2, 4, and 6. An exploration distribution may also include values that are outside of the values that are actually used by the AVs 202, so that the exploration distribution allows for the model architecture design system 220 to explore values that are outside of the current operational ranges (e.g., the range(s) of values used by the AVs 202). For example, an exploration distribution can include the values 1, 2, 4, 6, 12 for neural network kernel sizes. The range of the exploration distribution can be extended to include one or more other values in addition to those values (e.g., the values 1, 2, 4, 6, 12 in the example above) in order to allow for the exploration of values outside the current range (e.g., the range including values 1, 2, 4, 6, 12). The exploration distribution can also be extended by including more values internal to the distribution (for example, the values 2, 3, 4, 5, 6). The distribution is optimized to give sufficient granularity to maximize performance, while also keeping the distribution small enough to reduce a cost and difficulty of working with the distribution.

In some examples, the model architecture design system 220 can generate a distribution(s) for a target context (e.g., a target distribution). In some examples, the target context may not be part of the contexts of the AVs 202. In other words, a target context for an AV can pertain to at least one of a new or different location than a current location of the AV, a new or different hardware configuration than a current software configuration of the AV, a new or different software configuration than a current software configuration of the AV, and/or a new or different task than a current task of the AV. Here, the new or different location, hardware configuration, software configuration, and/or task may not be part of the location(s), hardware configuration(s), software configuration(s), and/or task(s) associated with the contexts of the AVs 202. As further explained herein, the model architecture design system 220 can use an exploration distribution(s) determined by the model architecture design system 220 to generate a distribution for a change in the hardware configuration 222, a distribution for a change in the software configuration 224, a distribution for a change in the location 226, and/or a distribution for a change in the task 228 based on the exploration distribution.

For example, if the current locations of the AVs 202 include San Francisco, Houston, and Los Angeles, a target context can include any other cities such as Boston or Miami. As follows, a distribution for a change in the location 226 can be searched for an optimal neural network parameter value (e.g., a desired neural network parameter value and/or a neural network parameter value estimated to have a desired effect/impact relating to an operation of an AV) for an AV (e.g., AV 102) that is navigating in a particular environment (e.g., Boston or Miami) that is not included in a distribution of environments and/or is different than other environments previously traversed by the AV. The model architecture design system 220 can search the distribution for the change in the location 226 to find the optimal neural network parameter value to use to tune and adapt the parameters and parameter values implemented by a neural network of the AV to that particular environment (e.g., Boston or Miami). In this way, the model architecture design system 220 can identify specific neural network parameter values that are optimal and/or tailored for an environment (e.g., estimated to have a desired effect/impact relating to an operation of the AV in that environment) even though the AV may not have previously driven in that environment (e.g., the environment may be new to that AV) and/or the neural network implemented by the AV may not already be used in that environment and/or tuned for that environment.

A target distribution(s) (e.g., a distribution for a target context) can be a subset of an exploration distribution. In other words, the target distribution(s) for a target context can include a reduced number of allowable/accepted values of one or more neural network parameters compared to an exploration distribution, which includes a larger number of allowable/accepted values of the one or more neural network parameters than the target distribution and/or an entire/total amount of allowable/accepted values of the one or more neural network parameters. Instead of using one distribution for every context or using an exploration distribution, which is a wider distribution than the target distribution (e.g., having a greater number of possible values) and includes more or all possible values/variations, to search and find values for one or more neural network parameters, the model architecture design system 220 can use a target distribution for a target context to reduce the search space for identifying an optimal neural network parameter (e.g., a desired neural network parameter value and/or a neural network parameter value estimated to have a desired effect/impact on an operation of an AV).

The subset of the exploration distribution for a given target context (e.g., the target distribution) can be determined by calculating the optimum tunable parameter value(s) (e.g., desired tunable parameter value(s) and/or tunable parameter value(s) estimated to have a certain effect and/or impact on an operation of an AV in the target context) in each environment in the target context (e.g., a combination of the HW configuration 222, SW configuration 224, location 226, and/or task 228) and then calculating the histogram of the optimum tunable parameter values. For example, to determine certain optimum tunable parameters such as optimum tunable kernel size parameters, if the target context is driving in Boston, and an AV (e.g., AV 102) has driven in Boston with three HW configurations (e.g., HW configuration 1, HW configuration 2, HW configuration 3) with each HW configuration being optimized by the model architecture design system 220 to yield optimum tunable kernel size parameter values (4, 4, 8), then the target distribution for kernel size parameters can include (4, 8) with respective weights (2, 1). The first weight in this example is 2 because there are two weights in the set with a same value of 4. Even though only one tunable parameter is described in the example, a histogram and corresponding distribution of tunable parameter values can be calculated in the same or similar way. As a post-processing step, the target distribution for a target context can be expanded, especially if the number of points in the histogram is small, to accommodate for any unexpected changes. For example, in the above example, the model architecture design system 220 can expand the target distribution to (2, 4, 8, 12) with weights (0.5, 2, 1, 0.5), to allow for some unexpected change in behavior.

Further, each distribution may be a set of discrete values or a continuous distribution with a mean and standard deviation or variance. Examples of types of distribution(s) can include, without limitation, a Gaussian distribution (e.g., a normal distribution), a uniform distribution, or any other distribution.

The model architecture design system 220 can use an exploration distribution to derive a target distribution for a given context. The model architecture design system 220 can then search the target distribution for optimal neural network parameter values to use in a neural network when the AV is in the given context. To illustrate, the model architecture design system 220 can receive AV driving data from one or more sensors of the AV 102. Based on the AV driving data, the model architecture design system 220 can determine a context of the AV 102 such as, for example, a location where the AV 102 is navigating, a hardware configuration of the AV 102, a software configuration of the AV 102, and/or a task of the AV 102. Alternatively, the model architecture design system 220 can identify the context of the AV 102 based on an input from a user, such as a developer, and/or an input from another device or algorithm. When the model architecture design system 220 determines that the context of the AV 102 includes a change and/or new data (e.g., data associated with a changed context and/or one or more changes to a context of the AV 102), such as a change in the hardware configuration 222, the software configuration 224, the location 226, and/or the task 228, the model architecture design system 220 can search a target distribution for a target context associated with the change and/or the new data in order to find and select an optimal neural network parameter (e.g., an optimal neural network parameter value). The model architecture design system 220 can find the optimal neural network parameter value within the target distribution and implement the optimal neural network parameter value (e.g., modify a neural network model to implement the optimal neural network parameter value) to adapt the AV 102 (e.g., to adapt a neural network implemented by the AV 102) to the change.

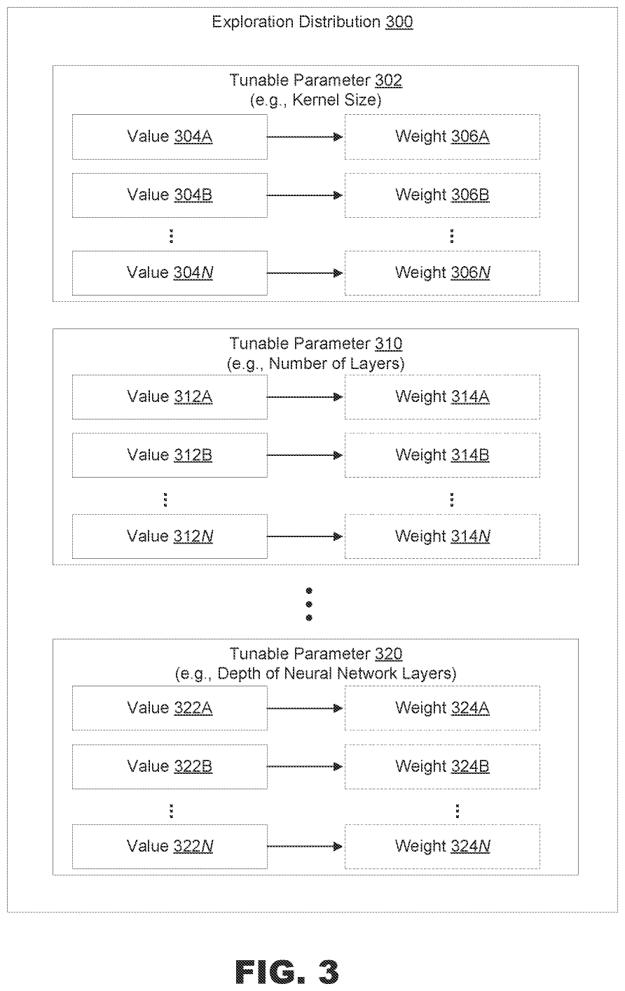

FIG. 3 is a diagram illustrating an example exploration distribution 300 generated for one or more neural networks implemented by one or more AVs. The exploration distribution 300 includes example tunable parameters 302, 310, and 320. The model architecture design system 220 can search the tunable parameters 302, 310, and 320 in the exploration distribution 300 for particular values of the tunable parameters 302, 310, and 320 that the model architecture design system 220 can use to configure a neural network(s) implemented by a computer system (e.g., local computing device 110) of the AV 102.

In this example, the tunable parameter 302, the tunable parameter 310, and the tunable parameter 320 correspond to kernel size, a number of layers, and a depth of neural network layers, respectively. For example, the tunable parameter 302 corresponds to a kernel size associated with the neural network(s), the tunable parameter 310 corresponds to a number of layers to use for the neural network(s), and the tunable parameter 320 corresponds to a depth of neural network layers to use for the neural network(s). However, in other examples, the exploration distribution 300 can include more or less parameters than shown in FIG. 3 and/or other parameters that are not shown in FIG. 3. The number and type of tunable parameters in FIG. 3 are merely non-limiting examples provided for illustration purposes.

As shown, the tunable parameter 302 can include potential values 304A through 304N of the tunable parameter 302. Similarly, the tunable parameter 310 can include potential values 312A through 312N of the tunable parameter 310, and the tunable parameter 320 can include potential values 322A through 322N of the tunable parameter 320. For example, if the tunable parameter 302 corresponds to kernel sizes, the values 304A through 304N of the tunable parameter 302 can include potential or possible kernel sizes that can be implemented by the neural network(s). If the tunable parameter 310 corresponds to a number of layers to use for the neural network(s), the values 312A through 312N of the tunable parameter 310 can include potential or possible number of layers that can be implemented by the neural network(s) and, if the tunable parameter 320 corresponds to a depth of neural network layers to use for the neural network(s), the values 322A through 322N of the tunable parameter 320 can include potential or possible depths of neural network layers that can be implemented by the neural network(s).

In some examples, the values (e.g., values 304A through 304N, values 312A through 312/V, or values 322A through 322/V) of a particular tunable parameter (e.g., tunable parameter 302, tunable parameter 310, or tunable parameter 320) can include all possible values of the tunable parameter. In other examples, the values of the tunable parameter can include a subset of all possible values of the tunable parameter. In yet other examples, the values of the tunable parameter can include all or a subset of all possible or potential values of the tunable parameter determined for one or more given contexts of an AV or all potential contexts of the AV. For example, the values 304A through 304N of the tunable parameter 302 can include all possible values of the tunable parameter 302, a subset of all possible values of the tunable parameter 302, or all or a subset of all possible or potential values of the tunable parameter 302 determined for one or more given contexts of an AV or all potential contexts of the AV.

The values of the tunable parameters 302, 310, and/or 320 can optionally include or be associated with weights. For example, the values 304A through 304N of the tunable parameter 302 can be associated with respective weights 306A through 306N, the values 312A through 312N of the tunable parameter 310 can be associated with respective weights 314A through 314N, and/or the values 322A through 322N of the tunable parameter 320 can be associated with respective weights 324A through 324N. The weight (e.g., a weight from the weights 306A through 306N, the weights 314A through 314N, or the weights 324A through 324/V) associated with a particular value (e.g., a value from the values 304A through 304N of the tunable parameter 302, the values 312A through 312N of the tunable parameter 310, or the values 322A through 322N of the tunable parameter 320) can include, for example and without limitation, a value representing a probability, an importance, and/or a bias of the particular value associated with the weight.

Moreover, the weight associated with a tunable parameter value can be used to bias a tunable parameter value search towards or against the tunable parameter value associated with that weight. For example, the weight 306A of the value 304A of the tunable parameter 302 can indicate an importance or probability of that value 304A within the tunable parameter 302 in the exploration distribution 300 and/or relative to the other values (e.g., value 304B through 304/V) of the tunable parameter 302 in the exploration distribution 300. The weight 306B of the value 304B of the tunable parameter 302 can indicate an importance or probability of that value 304B within the tunable parameter 302 in the exploration distribution 300 and/or relative to the other values (e.g., value 304A and 304/V) of the tunable parameter 302 in the exploration distribution 300, and the weight 306N of the value 304N can indicate an importance or probability of that value 304N within the tunable parameter 302 in the exploration distribution 300 and/or relative to the other values (e.g., value 304A and 304B) of the tunable parameter 302 in the exploration distribution 300.

The importance or probability indicated by the respective weights 306A through 306N of the values 304A through 304N of the tunable parameter 302 can thus bias a search for a value(s) of the tunable parameter 302 towards or against the values 304A through 304N, depending on the specific weights. To illustrate, if the weights can include a value between 0 and 1 where 0 means that the value associated with that weight has 0% probability or the lowest importance and 1 means that the value associated with that weight has 100% probability or the highest importance, then as the weight increases, the parameter associated with that weight is given (and/or treated as having) a higher importance or probability, and as the weight decreases, the parameter associated with that weight is given (and/or treated as having) a lower importance or probability. In other words, when the model architecture design system 220 searches the exploration distribution 300 for a value of a tunable parameter (e.g., tunable parameters 302, 310, and/or 320), for example, for determining parameter values of a target distribution, the model architecture design system 220 is more likely to select a value having a higher weight than a value having a lower weight and/or is likely to spend more time considering a value that has a higher weight than a value that has a lower weight.

The exploration distribution 300 includes the tunable parameters 302, 310, and 320 described above with respect to FIG. 3. However, as previously noted, the exploration distribution 300 can include different tunable parameters and/or more or less tunable parameters than shown in FIG. 3.

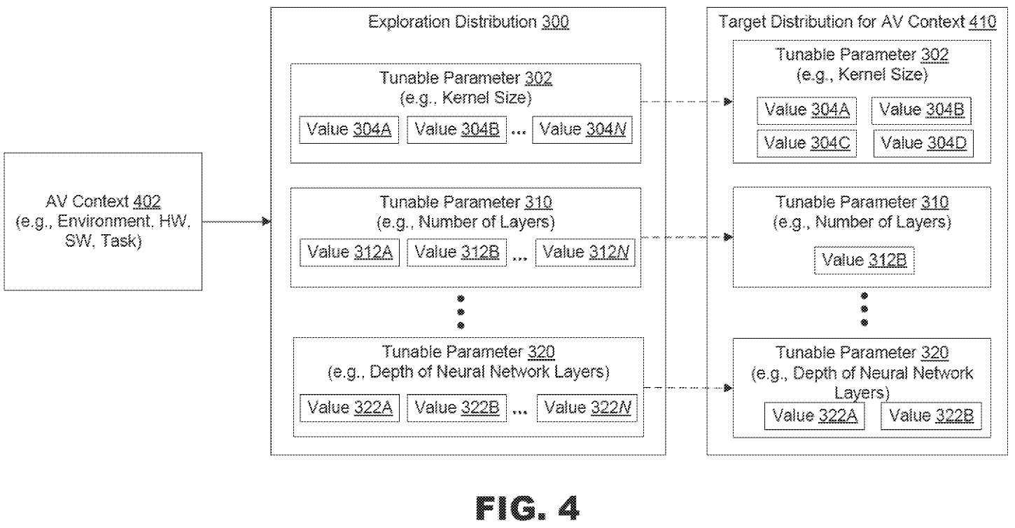

FIG. 4 is a diagram illustrating an example target distribution 410 generated and/or selected for a particular AV context 402. The AV context 402 in this example can include, without limitation, an environment associated with the AV (e.g., a physical scene and/or location of the AV), a hardware configuration (e.g., a type, version, and/or number of physical components (e.g., mechanical components, electrical components, compute components, etc.); a software configuration (e.g., a type and/or version of one or more software platforms and/or components implemented by the AV, one or more settings of a software implemented by the AV, specific software components implemented by the AV, one or more functionalities/capabilities of a software implemented by the AV, an operating system of the AV, etc.); one or more tasks implemented by the AV (e.g., one or more maneuvers, one or more operations, etc.); and/or a combination thereof.

The target distribution 410 can be generated and/or selected from an exploration distribution 300. In other words, the target distribution 410 of a tunable parameter can include a subset of the tunable parameter values in the exploration distribution 300 of the tunable parameter (e.g., a value from the values 304A through 304N of the tunable parameter 302, the values 312A through 312N of the tunable parameter 310, or the values 322A through 322N of the tunable parameter 320). The tunable parameter values in the target distribution 410 can be selected/tailored for the particular AV context 402. More specifically, the subset of tunable parameter values can include one or more of the tunable parameter values in the exploration distribution 300 estimated to include the most relevant, important, and/or effective for the AV context 402. In other words, the subset of tunable parameter values in the exploration distribution 300 can include one or more of the tunable parameter values in the exploration distribution 300 estimated to yield the highest safety and/or performance metrics when implemented by a neural network used by the AV (e.g., used to operate the AV) in the AV context 402. For example, the target distribution 410 for the tunable parameter 302 (e.g., kernel size) can include one or more tunable parameter values (e.g., values 304A, 304B, 304C, 304D), which is a subset of tunable parameter values (e.g., values 304A through 304/V) from the exploration distribution 300 for the tunable parameter 302 (e.g., kernel size). In another example, the target distribution 410 for the tunable parameter 310 (e.g., number of layers) can include value 312B, which is selected from the set of values, values 312A through 312N in the exploration distribution 300 for the tunable parameter 310 (e.g., number of layers). Also, the target distribution 410 for the tunable parameter 320 (e.g., depth of neural network layers) can include values 322A and 322B, which are selected from the set of values, values 322A through 312N in the exploration distribution 300 for the tunable parameter 320 (e.g., depth of neural network layers).

For example, the tunable parameter value(s) for a tunable parameter in the target distribution 410 can include a subset of tunable parameter values for the corresponding tunable parameter from the exploration distribution 300 that are determined to be most important (e.g., with respect to the particular AV context 402) tunable parameter values in the exploration distribution 300 (e.g., the top n number of most important tunable parameter values from all of the tunable parameter values in the exploration distribution 300 for the tunable parameter or the tunable parameter values having at least a threshold importance with respect to the AV context 402), the n number of tunable parameter values in the exploration distribution 300 that are most relevant to the AV context 402 for the tunable parameter (e.g., the n number most relevant tunable parameter values from the exploration distribution 300 or the tunable parameter values having at least a threshold relevance to the AV context 402 for the tunable parameter), and/or the tunable parameter values having the highest probabilities (e.g., the n number of tunable parameter values having the highest probabilities from the tunable parameter values in the exploration distribution 300 and/or the tunable parameter values having at least a threshold probability with respect to the AV context 402 for the tunable parameter) of being relevant to the AV context 402 (and/or producing a particular result and/or impact if implemented by a neural network(s) of the AV associated with the AV context 402). As noted above, in some examples, the importance or probability of each value of tunable parameters (e.g., the value 304A through 304N, the values 312A through 312N, or the values 322A through 322/V) is based on the corresponding weight (e.g., the weights 306A through 306N, the weights 314A through 314N, or the weights 324A through 324/V).

In some examples, the tunable parameter value(s) in the target distribution 410 for a particular tunable parameter can include the top n number of tunable parameter values (e.g., most frequent n number of tunable parameter values) from the exploration distribution 300 for the particular tunable parameter. In other words, the tunable parameter value(s) in the target distribution 410 for a particular tunable parameter can include the top n number of tunable parameter values from the exploration distribution 300 estimated to be the top n most important and/or relevant to the AV context 402 from all of the tunable parameter values in the exploration distribution 300. In some cases, the tunable parameter value(s) in the target distribution 410 can additionally or alternatively include n number of tunable parameter values from the exploration distribution 300 based on safety and/or performance metrics (e.g., relative to other tunable parameter values in the exploration distribution 300) when implemented by a neural network used by the AV (e.g., used to operate the AV) in the AV context 402. As noted, each tunable parameter value can be associated with a weight that corresponds to the importance or probability (e.g., relevance to a certain AV context, a frequency in an exploration distribution, etc.). As follows, in some examples, the tunable parameter values for the target distribution 410 of a particular tunable parameter can be selected from the tunable parameter values in the exploration distribution 300 based on associated weights. The tunable parameter values in the target distribution 410 (e.g., for the tunable parameters 302, 310, 320) can be selected from the tunable parameter values in the exploration distribution 300 (e.g., a value from the values 304A through 304N of the tunable parameter 302, the values 312A through 312N of the tunable parameter 310, or the values 322A through 322N of the tunable parameter 320, respectively) based on one or more factors such as, for example and without limitation, one or more metrics (e.g., safety metrics, performance metrics, etc.) estimated for the tunable parameter values in the exploration distribution 300, historical performance data generated and/or collected for the tunable parameter values in the exploration distribution 300 from implementation of such tunable parameter values in other AV contexts, a similarity between the AV context 402 and other contexts associated with the tunable parameter values in the exploration distribution 300, results of a simulation that includes a simulated implementation and performance of the tunable parameter values from the exploration distribution 300 in a simulated context (e.g., a simulation of the AV context 402, a simulation of an AV context(s) having a threshold similarity to the AV context 402, and/or a simulation of one or more other AV contexts), and/or any other factors.

For example, the tunable parameter values in the target distribution 410 (e.g., for the tunable parameters 302, 310, 320) can be selected from the tunable parameter values in the exploration distribution 300 (e.g., a value from the values 304A through 304N of the tunable parameter 302, the values 312A through 312N of the tunable parameter 310, or the values 322A through 322N of the tunable parameter 320, respectively) based on one or more metrics obtained for some or all of the tunable parameter values in the exploration distribution 300 in previous implementations of such tunable parameter values in other AV contexts. In some examples, the other AV contexts associated with the previous implementations of such tunable parameter values can include one or more AV contexts having a threshold similarity (and/or having the most similarity to) the AV context 402. A similarity between the AV context 402 and any other AV contexts can be determined based on a similarity or match between locations and/or environments associated with the AV context 402 and the other AV contexts, a similarity between or match between scene elements associated with the AV context 402 and the other AV contexts, a similarity or match between a hardware and/or software configuration of the AV in the AV context 402 and a hardware and/or software configuration of the AV (and/or another AV) in the other AV contexts, a similarity or match between one or more tasks of the AV in the AV context 402 and one or more tasks of the AV (and/or another AV) in the other AV contexts, a complexity of a scene associated with the AV context 402 and a complexity of a scene(s) associated with the other AV contexts, and/or a similarity or match between any other aspects of the AV context 402 and the other AV contexts.

As another example, the tunable parameter values in the target distribution 410 (e.g., for the tunable parameters 302, 310, 320) can be selected from the tunable parameters 302, 310, 320 in the exploration distribution 300 (e.g., a value from the values 304A through 304N of the tunable parameter 302, the values 312A through 312N of the tunable parameter 310, or the values 322A through 322N of the tunable parameter 320, respectively) based on one or more metrics estimated for various tunable parameter values (or all tunable parameter values) in the exploration distribution 300 in one or more AV contexts (e.g., real and/or simulated AV contexts). Here, the one or more AV contexts can include one or more AV contexts selected from a set of AV contexts (e.g., real and/or simulated) previously used to obtain metrics associated with the tunable parameter values in the exploration distribution 300 (e.g., a value from the values 304A through 304N of the tunable parameter 302, the values 312A through 312N of the tunable parameter 310, or the values 322A through 322N of the tunable parameter 320). Such one or more AV contexts can be selected from the set of AV contexts arbitrarily or based on one or more factors such as, for example, an estimated relevance to the AV context 402, a similarity or match between one or more aspects (e.g., a location and/or environment, a hardware configuration, a software configuration, an AV task, scene elements, etc.) of the AV context 402 and the other AV contexts, a complexity of a scene associated with the AV context 402 and one or more scenes associated with the other AV contexts, and/or any other factors.

In some cases, if the tunable parameter values in the exploration distribution 300 (e.g., a value from the values 304A through 304N of the tunable parameter 302, the values 312A through 312N of the tunable parameter 310, or the values 322A through 322N of the tunable parameter 320) include or are associated with weights, the tunable parameter value(s) in the target distribution 410 can be selected from the exploration distribution 300 based on the weights associated with the tunable parameter values in the exploration distribution 300 (e.g., a weight from the weights 306A through 306N associated with the values 304A through 304N of the tunable parameter 302, respectively, the weights 314A through 314N associated with the values 312A through 312N of the tunable parameter 310, respectively, or the weights 324A through 324N associated with the values 322A through 322N of the tunable parameter 320, respectively). For example, if the tunable parameter 302 (e.g., kernel size) in the exploration distribution 300 includes various values (e.g., values 304A through 304/V) for that specific tunable parameter and respective weights (e.g., weights 306A through 306N, respectively) associated with the various values, the tunable parameter value(s) in the target distribution 410 for the tunable parameter 302 (e.g., kernel size) can include a particular value (e.g., value 304A) selected from the various values such as, for example, the value having the highest weight or a value having a threshold weight.

As previously noted, the tunable parameters 302, 310, 320 can include for example and without limitation, a kernel size, a number of neural network layers, a depth of neural network layers (e.g., a number of neurons/nodes in each neural network layer), a learning rate, and/or a number of neural network branches, among other tunable parameters. Moreover, the tunable parameters 302, 310, 320 can include a number of tunable parameter values. For example, if the tunable parameter 302 is a kernel size, a distribution of the tunable parameter 302 can include specific values indicating the kernel size. If the tunable parameter 310 is a number of neural network layers, a distribution of the tunable parameter 310 can include specific values indicating the number of neural network layers. If the tunable parameter 320 is a depth of neural network layers, a distribution of the tunable parameter 320 can include specific values indicating the depth of neural network layers. if a particular tunable parameter is associated with a learning rate, a distribution of the learning rate can include specific values indicating the learning rate to implement in a neural network(s) (e.g., used to design an architecture and/or any other aspect of the neural network(s)).

In some cases, the target distribution 410 of a particular tunable parameter can include multiple, tunable parameter value options. For example, if a target distribution 410 of the tunable parameter 302 includes a tunable parameter defining a kernel size to use for a neural network, the kernel size tunable parameter can include multiple kernel size values, which can provide different kernel size options for the neural network(s) being implemented (and/or to be implemented) in the AV context 402. The model architecture design system 220 can thus select a particular kernel size option (e.g., an optimal kernel size option) from multiple available kernel size options to implement in the neural network(s) that the model architecture design system 220 designs for the AV context 402. To illustrate, if the kernel size tunable parameter includes the set of values [2, 5, 6, 10], the model architecture design system 220 can select a particular value (e.g., an optimal value) from the set such that the neural network designed by the model architecture design system 220 for the AV context 402 will have a kernel size of 2, 5, 6, or 10, depending on the value selected from the set.

The values associated with the tunable parameters 302, 310, 320 in the target distribution 410 can optionally include or be associated with weights. The model architecture design system 220 can use the weights associated with the values to select a particular value to implement for the AV context 402 (e.g., to implement in a neural network designed for use in the AV context 402). In some examples, each of the weights associated with a respective tunable parameter value can indicate a respective importance, relevance, and/or fit or match of that value with respect to the AV context 402 and/or relative to the other values. The weights can then be used to select a particular tunable parameter value (e.g., an optimal tunable parameter value) and/or guide the search for a tunable parameter value (e.g., and/or guide how much time, effort, and/or resources the model architecture design system 220 spends assessing each of the tunable parameter values) from the various tunable parameter value options.

For example, in the previous example where a kernel size tunable parameter includes the set of values [2, 5, 6, 10], each of the values in the set of values [2, 5, 6, 10] can be associated with a weight indicating the importance, relevance, and/or fit or match of that value with respect to the AV context 402 and relative to the other values in the set. To illustrate, if the set of values [2, 5, 6, 10] is associated with the weights [0.4, 0.5, 0.3, 0.8] from a weight range of 0 to 1, where the value 2 is associated with the weight 0.4, the value 5 is associated with the weight 0.5, the value 6 is associated with the weight 0.3, and the value 10 is associated with the weight 0.8, the model architecture design system 220 may select the value 10 because it has the highest weight (e.g., 0.8 or 80%) which indicates that the value 10 is the most important, the most relevant, the best fit, and/or the best match for the AV context 402.

In other examples, the model architecture design system 220 can use the weights (e.g., 0.4, 0.5, 0.3, 0.8) associated with the values to inform the model architecture design system 220 on how much time to spend assessing the various values for use in the neural network being designed for the AV context 402. For example, the weight 0.8 can indicate that the model architecture design system 220 should spend the most time assessing the value 10 associated with the weight 0.8 as that weight 0.8 is the highest weight from the weights associated with the set of values for a particular tunable parameter, the weight 0.3 associated with the value 6 can indicate that the model architecture design system 220 should spend the least amount of time assessing the value 6 associated with the weight 0.3 as the weight 0.3 is the lowest weight from the weights associated with the set of values for the particular tunable parameter, and so forth.

In some cases, on one end, a weight of 1.0 associated with a tunable parameter value can indicate that the model architecture design system 220 should implement that tunable parameter value in the neural network for the AV context 402 and/or should devote the time needed in assessing and/or selecting the particular value in the target distribution 410 for that tunable parameter. On the other end, a weight of 0 associated with a tunable parameter value can indicate that the model architecture design system 220 should not implement that tunable parameter value in the neural network for the AV context 402 and/or should devote a minimal amount of time, effort, and/or resources (e.g., should devote a minimum threshold amount of time, effort, and/or resources) in assessing and/or selecting the particular value in the target distribution 410 for that tunable parameter.

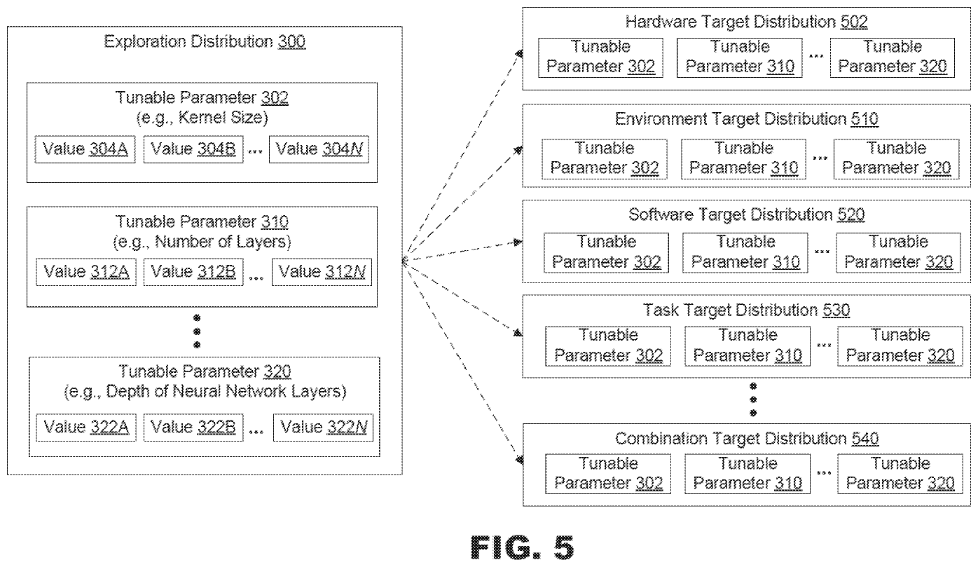

FIG. 5 is a diagram illustrating example target distributions generated from an exploration distribution 300. As previously explained, the exploration distribution 300 can be used to generate target distributions for different AV contexts. Moreover, each target distribution can be tailored and/or specific to a respective AV context.

In the example shown in FIG. 5, the exploration distribution 300 is used to determine a hardware target distribution 502 for an AV context involving a specific AV hardware configuration, an environment target distribution 510 for an AV context involving a specific environment, a software target distribution 520 for an AV context involving a specific AV software configuration, a task target distribution 530 for an AV context involving a specific task(s), and a combination target distribution 540 for an AV context involving a combination of aspects such as, for example, a combination of an AV hardware configuration, an AV environment, an AV software configuration, and/or an AV task(s).

The hardware target distribution 502 of a particular tunable parameter can include tunable parameter values selected from the tunable parameter values in the exploration distribution 300 of the corresponding tunable parameter for a particular AV context involving a hardware configuration, the environment target distribution 510 of a particular tunable parameter can include tunable parameter values selected from the tunable parameter values in the exploration distribution 300 of the corresponding tunable parameter for a particular AV context involving a specific AV environment (e.g., location), the software target distribution 520 of a particular tunable parameter can include tunable parameter values selected from the tunable parameter values in the exploration distribution 300 of the corresponding tunable parameter for a particular AV context involving a software configuration, the task target distribution 530 of a particular tunable parameter can include tunable parameter values selected from the tunable parameter values in the exploration distribution 300 of the corresponding tunable parameter for a particular AV context involving an AV task(s), and the combination target distribution 540 of a particular tunable parameter can include tunable parameter values selected from the tunable parameter values in the exploration distribution 300 of the corresponding tunable parameter for a particular AV context involving a combination of contextual characteristics (e.g., a hardware configuration, an environment, a software configuration, and/or an AV task).

The tunable parameter values in the target distributions (e.g., the hardware target distribution 502, the environment target distribution 510, the software target distribution 520, the task target distribution 530, and the combination target distribution 540) of a particular tunable parameter (e.g., the tunable parameters 302, 310, or 320) can include a subset of the tunable parameter values in the exploration distribution 300 of the corresponding tunable parameter (e.g., the tunable parameters 302, 310, or 320). The subset of tunable parameter values in each target distribution can include one or more tunable parameter values tailored for and/or specifically selected for an AV context associated with that target distribution of a particular tunable parameter. Such tunable parameter values for the target distribution can be selected as previously described above with respect to FIGS. 2 and 4.

By reducing the number of tunable parameter values in each target distribution relative to the number of parameter values in the exploration distribution 300, each target distribution can reduce the number of tunable parameter values to search for each tunable parameter value for a given AV context and/or reduce the number of tunable parameter value options for use in a given AV context. Such reduction in the tunable parameter value search space and/or the tunable parameter value options can in turn increase the speed and/or efficiency in determining tunable parameter values for a given AV context, limit the search space to the more important, relevant, and/or impactful (e.g., in terms of safety and/or performance metrics) tunable parameter values for a given AV context, reduce the compute footprint (e.g., the amount of compute) and/or other resources used to determine the tunable parameter values to implement for a given AV context, reduce a latency in searching and/or finding tunable parameters for a given AV context, and/or avoid the less relevant, important, and/or impactful parameters for a given AV context.

For example, when determining what tunable parameter values for a certain tunable parameter (e.g., kernel size) to use when designing or adjusting a neural network for a particular AV context involving the hardware configuration associated with the hardware target distribution 502, the model architecture design system 220 can search (and select from) the hardware target distribution 502 of the corresponding tunable parameter (e.g., kernel size) for one or more tunable parameter values suitable for the AV context involving the hardware configuration, rather than searching the entire exploration distribution 300 of the corresponding tunable parameter (e.g., kernel size) for such one or more tunable parameter values. The model architecture design system 220 can thus limit the search to the tunable parameter values in the hardware target distribution 502, instead of searching the tunable parameter values in the exploration distribution 300. Similarly, when determining what tunable parameter value(s) to use when designing or adjusting a neural network for a particular AV context involving the environment associated with the environment target distribution 510, the model architecture design system 220 can search (and select from) the environment target distribution 510 of a particular tunable parameter for one or more tunable parameter value(s) suitable for the AV context involving that environment rather than searching the entire exploration distribution 300 for such one or more tunable parameter value(s).

Moreover, when determining what tunable parameter values to use for a particular AV context involving the software configuration associated with the software target distribution 520, the model architecture design system 220 can search (and select from) the software target distribution 520 for one or more tunable parameter values suitable for the AV context involving the software configuration rather than searching the entire exploration distribution 300 for such one or more tunable parameter values, when determining what tunable parameter values to use for a particular AV context involving the task(s) associated with the task target distribution 530, the model architecture design system 220 can search (and select from) the task target distribution 530 for one or more tunable parameter values suitable for the AV context involving the task(s) rather than searching the entire exploration distribution 300 for such one or more tunable parameter values, and when determining what tunable parameter values to use for a particular AV context involving a combination of contextual characteristics associated with the combination target distribution 540, the model architecture design system 220 can search (and select from) the combination target distribution 540 for one or more tunable parameter values suitable for the AV context involving the combination of contextual characteristics rather than searching the entire exploration distribution 300 for such one or more tunable parameter values.

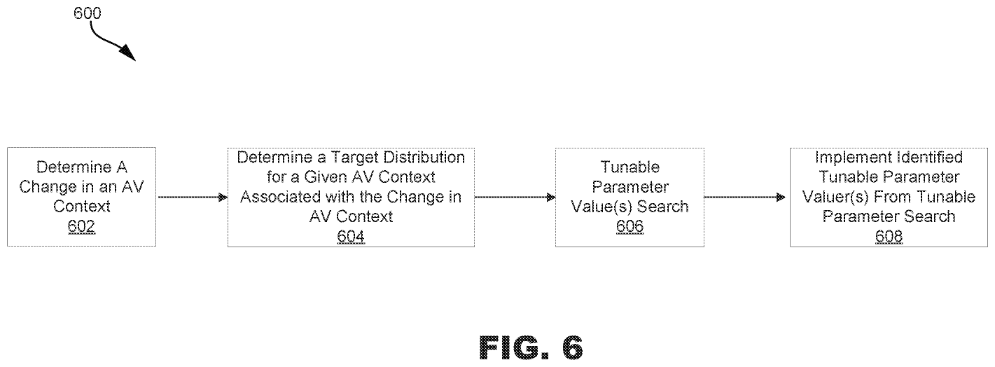

FIG. 6 is a flowchart illustrating an example process 600 for determining a target distribution (e.g., target distribution 410) of tunable neural network parameters for a given AV context. At block 602, the process 600 can include determining a change in an AV context. In some examples, model architecture design system 220 can determine a specific AV context that is different than a current context of an AV (e.g., AV 102) or that is different from one or more AV contexts that are already associated with a specific target distribution. In yet other examples, the process 600 can detect the AV context change based on AV data collected from one or more AVs while operating in one or more AV contexts. The AV data can include measurements/metrics collected by the one or more AVs while operating in the AV contexts. In some cases, the process 600 can test various possible combinations of a location/environment, a hardware configuration, a software configuration, and/or a task of an AV The process 600 can test such combinations in simulation (e.g., in a simulated test) and/or in a real-world test, in order to collect data and evaluate possible contexts.

At block 604, the process 600 can determine a target distribution for a given AV context associated with the AV context change as determined at block 602. In some examples, the process 600 can include searching an exploration distribution (e.g., exploration distribution 300) of a particular neural parameter for tunable neural network parameter values to generate a target distribution for the given AV context, as previously described with respect to FIGS. 2 through 5. In some examples, an exploration distribution of a neural network parameter can include every value of the tunable neural network parameter determined for the given AV context.

The given AV context associated with the target distribution can correspond to the AV context change determined at block 602. In some examples, the given AV context can include new and/or different AV circumstances and/or contextual characteristics, as previously explained. For example, the given AV context can include a new or different location/environment, a new or different hardware configuration, a new or different software configuration, and/or a new or different task of an AV associated with the AV context change determined at block 602. In some examples, the target distribution for a given AV context can include less tunable parameter values than the exploration distribution used to determine the target distribution.

At block 606, the process 600 can include conducting a parameter value search using the target distribution. The parameter search can include searching tunable neural network parameter values in the target distribution for implementation in a neural network tailored/designed for the given AV context (e.g., the AV context change determined at block 602) associated with the target distribution. The process 600 can conduct the parameter value search to identify one or more optimal tunable neural network parameter values from the target distribution.

The one or more optimal tunable neural network parameter values can include one or more tunable parameter values from the target distribution determined to have a highest or a threshold importance, a highest or threshold relevance to the given AV context, a lowest cost (and/or a cost below a threshold) associated with a use in the given AV context, and/or one or more threshold metrics (e.g., safety metrics, performance metrics, and/or any other metrics) when implemented by a neural network in the given AV context (and/or one or more threshold metrics estimated if implemented in the given AV context). In some examples, the one or more optimal tunable neural network parameter values can be selected from the target distribution (e.g., during conducting the parameter value search at block 606) based on one or more factors, metrics, outcomes, and/or algorithms such as, for example and without limitation, a search algorithm, a search cost function, a safety metric, a comfort metric, a specific outcome, and/or a performance metric of an AV An example search algorithm used to search the target distribution and identify the one or more optimal tunable neural network parameter values can include, without limitation, a Bayesian optimization algorithm, a reinforcement learning algorithm, and/or any other search and/or learning/training algorithm.

In some cases, the process 600 can search a target distribution for a given AV context and select the one or more optimal tunable neural network parameter values based on a search cost function (e.g., during conducting the parameter search at block 606). For example, the process 600 use a search cost function to select a tunable neural network parameter value(s) that minimizes a cost estimated by a cost function.

In some aspects, the process 600 can search a target distribution for a given AV context and select the one or more optimal tunable neural network parameter values based on a safety metric, a comfort metric, and/or a performance metric calculated for a neural network having the one or more optimal tunable neural network parameter values when or if implemented by an AV in the given AV context (e.g., during conducting the parameter value search at block 606). For example, the process 600 can select, from the target distribution, a tunable neural network parameter value(s) estimated to yield a highest or threshold safety, comfort, and/or performance metric when implemented in a neural network for use by an AV in the given AV context. The one or more optimal tunable neural network parameter values selected from the target distribution can allow a neural network implemented by the AV to adapt to the given AV context (e.g., a given driving environment and/or location and/or one or more given AV characteristics such as a hardware configuration, a software configuration, and/or a task) associated with the target distribution (and thus associated with the one or more optimal tunable neural network parameter values selected).

In some examples, the process 600 can adjust the exploration distribution used to derive the target distribution. The process 600 can adjust the exploration distribution based on, for example, the selected tunable neural network parameter value(s). For example, if the process 600 determines that the value 5 for a kernel size is never optimal in any scenario, the value 5 can be removed from the exploration distribution as a possible or available kernel size parameter value.

At block 608, the process 600 can include implementing the one or more optimal tunable neural network parameter values selected from the target distribution for a given AV context so that the AV (e.g., AV 102) can operate with a neural network having the one or more optimal tunable neural network parameter values and thus can be better adapted to the given AV context. For example, the process 600 can modify a neural network to implement the one or more optimal tunable neural network parameter values identified in the tunable parameter value search performed at block 606. To illustrate, if the process 600 identifies a kernel size of 6 in the tunable parameter value search performed at block 606, the process 600 at block 608 can modify a neural network implemented by the AV to use a kernel size of 6.

The process 600 can select the one or more optimal tunable neural network parameter values based on one or more factors. For example, in some cases, the process 600 can select the one or more optimal tunable neural network parameter values based on weights associated with specific values of tunable neural network parameters. To illustrate, if the target distribution includes a number of values for a particular neural network parameter and each of the values is associated with a weight indicating a relative importance, priority, relevance, and/or rank of that weight, the process 600 can select the value for that tunable neural network parameter having the highest weight.

In some cases, the process 600 can compare an amount of change in the context of an AV against a threshold. If the amount of change exceeds the threshold, the process 600 can update a neural network used by an AV stack of the AV with the one or more optimal tunable neural network parameter values selected from the target distribution for the given AV context and operate the AV with the adjusted neural network.

In some examples, distributions (including an exploration distribution and/or a target distribution for a given AV context) can be provided to a developer or an AV operator (for example, visually) so that the developer can better understand the sensitivity of the algorithms.

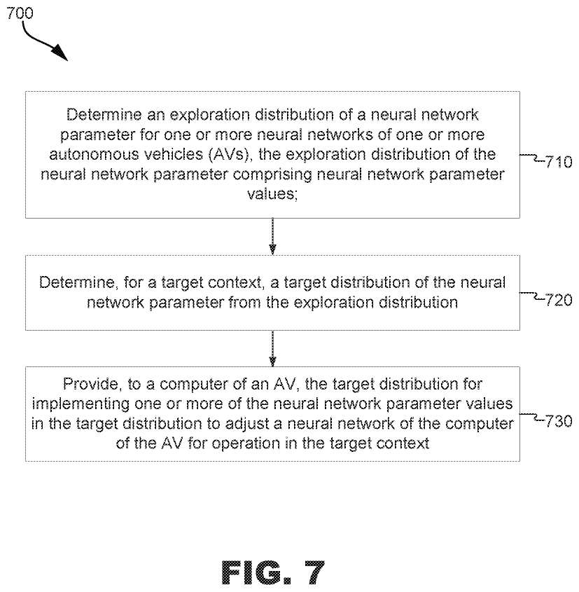

FIG. 7 is a flowchart illustrating an example process 700 for determining tunable neural network parameter values from a target distribution to implement in a neural network used for an AV context. Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence.

At step 710, the process 700 includes determining an exploration distribution of a neural network parameter for one or more neural networks of one or more AVs. The exploration distribution of the neural network parameter includes neural network parameter value(s). For example, system 200 as illustrated in FIG. 2 can determine the exploration distribution 300 of a neural network parameter (e.g., tunable parameters 302, 310, or 320) for one or more neural networks of one or more AVs.

At step 720, the process 700 includes determining a target distribution of the neural network parameter from the exploration distribution for a target context. The target context can comprise at least one of a driving environment associated with a location, a hardware configuration of one or more AVs, a software configuration of the one or more AVs, and a task of the one or more AVs. For example, system 200 can determine the target distribution 410 of neural network parameter (e.g., tunable parameters 302, 310, or 320) from the exploration distribution for a target context. In some examples, one or more neural network parameter values in the target distribution for a particular neural parameter can be a subset of the neural network parameter values in the exploration distribution of the particular neural parameter.

At step 730, the process 700 includes providing the target distribution to a model architecture design system (e.g., the model architecture design system 220 as illustrated in FIG. 2 or a computer associated with the AV) for implementing one or more of the neural network parameter values in the target distribution to adjust a neural network of the computer associated with the AV for operation in the target context. In particular, the target distribution for the target context can be provided directly or indirectly to the model architecture design system 220 for implementing the adjusted neural network parameter value(s) so that the neural network of the AV can adapt to a given context. In some examples, the distribution for the target context can be directly provided to the model architecture system 220 so that the AV can implement the adjusted neural network parameter value(s) selected from the distribution for the target context. In other examples, the distribution for the target context can be provided to an entity (e.g., a company or AV manufacturer) that may implement an AV or adjust an AV with neural network parameter value(s) that are selected from the target distribution for the target context.

In FIG. 8, the disclosure now turns to a discussion of example neural network models that can be implemented by AVs in accordance with the systems and techniques described herein. FIG. 8 is an example of a deep learning neural network 800 that can be used to implement all or a portion of the systems and techniques described herein (e.g., neural network 800 can be used to implement a perception module (or perception system) as discussed above). An input layer 820 can be configured to receive sensor data and/or data relating to an environment surrounding an AV. The neural network 800 includes multiple hidden layers 822A, 822B, through 822N. The hidden layers 822A, 822B, through 822N include “N” number of hidden layers, where “n” is an integer greater than or equal to one. The number of hidden layers can be made to include as many layers as needed for the given application. The neural network 800 further includes an output layer 21 that provides an output resulting from the processing performed by the hidden layers 822A, 822B, through 822N. In one illustrative example, the output layer 821 can provide estimated treatment parameters, that can be used/ingested by a differential simulator to estimate a patient treatment outcome.

The neural network 800 is a multi-layer neural network of interconnected nodes. Each node can represent a piece of information. Information associated with the nodes is shared among the different layers and each layer retains information as information is processed. In some cases, the neural network 800 can include a feed-forward network, in which case there are no feedback connections where outputs of the network are fed back into itself. In some cases, the neural network 800 can include a recurrent neural network, which can have loops that allow information to be carried across nodes while reading in input.

Information can be exchanged between nodes through node-to-node interconnections between the various layers. Nodes of the input layer 820 can activate a set of nodes in the first hidden layer 822A. For example, as shown, each of the input nodes of the input layer 820 is connected to each of the nodes of the first hidden layer 822A. The nodes of the first hidden layer 822A can transform the information of each input node by applying activation functions to the input node information. The information derived from the transformation can then be passed to and can activate the nodes of the next hidden layer 822B, which can perform their own designated functions. Example functions include convolutional, up-sampling, data transformation, and/or any other suitable functions. The output of the hidden layer 822B can then activate nodes of the next hidden layer, and so on. The output of the last hidden layer 822N can activate one or more nodes of the output layer 821, at which an output is provided. In some cases, while nodes in the neural network 800 are shown as having multiple output lines, a node can have a single output and all lines shown as being output from a node represent the same output value.

In some cases, each node or interconnection between nodes can have a weight that is a set of parameters derived from the training of the neural network 800. Once the neural network 800 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 820 using the different hidden layers 822A, 822B, through 822N in order to provide the output through the output layer 821.

In some cases, the neural network 800 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 800 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 800 can perform a backward pass by determining which inputs (weights) most contributed to the loss of the network, and can adjust the weights so that the loss decreases and is eventually minimized.

The neural network 800 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 800 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 9 illustrates an example processor-based system with which some aspects of the subject technology can be implemented. For example, processor-based system 900 can be any computing device making up, or any component thereof in which the components of the system are in communication with each other using connection 905. Connection 905 can be a physical connection via a bus, or a direct connection into processor 910, such as in a chipset architecture. Connection 905 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 900 includes at least one processing unit (Central Processing Unit (CPU) or processor) 910 and connection 905 that couples various system components including system memory 915, such as Read-Only Memory (ROM) 920 and Random-Access Memory (RAM) 925 to processor 910. Computing system 900 can include a cache of high-speed memory 912 connected directly with, in close proximity to, or integrated as part of processor 910.

Processor 910 can include any general-purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms known to those of skill in the art. In some instances, multimodal systems can enable a user to provide multiple types of input/output to communicate with computing system 900. Computing system 900 can include communication interface 940, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 930 can include software services, servers, services, etc., that when the code that defines such software is executed by the processor 910, it causes the system 900 to perform a function. In some embodiments, a hardware service that performs a particular function can include the software component stored in a computer-readable medium in connection with the necessary hardware components, such as processor 910, connection 905, output device 935, etc., to carry out the function.

Examples and aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other aspects of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various examples and aspects described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: determining an exploration distribution of a neural network parameter for one or more neural networks of one or more autonomous vehicles (AVs), the exploration distribution of the neural network parameter comprising neural network parameter values; determining, for a target context, a target distribution of the neural network parameter from the exploration distribution, the target context comprising at least one of a driving environment associated with a location, a hardware configuration of one or more AVs, a software configuration of the one or more AVs, and a task of the one or more AVs; and providing, to a computer of an AV, the target distribution for implementing one or more of the neural network parameter values in the target distribution to adjust a neural network of the computer of the AV for operation in the target context.

Aspect 2. The method of Aspect 1, further comprising: implementing a subset of the neural network parameter values in the target distribution in the neural network of the AV in the target context.

Aspect 3. The method of Aspect 1 or 2, wherein the neural network parameter values in the target distribution comprise a subset of the neural network parameter values in the exploration distribution.

Aspect 4. The method of any of Aspects 1 to 3, further comprising: determining a context of the AV, the context comprising at least one of a driving environment associated with a location of the AV, a hardware configuration of the AV, a software configuration of the AV, and a task of the AV; and in response to determining that the context of the AV corresponds to the target context, selecting the one or more of the neural network parameter values in the target distribution for the target context to adjust the neural network of the computer of the AV.

Aspect 5. The method of Aspect 4, further comprising: in response to determining that an amount of change in the context of the AV exceeds a threshold, updating a neural network of a stack of the AV with the selected one or more of the neural network parameter values.

Aspect 6. The method of Aspect 4, wherein selecting the one or more of the neural network parameter values includes: searching the target distribution for determining the one or more of the neural network parameter values based on at least one of the target context and a search algorithm, the search algorithm comprising at least one of Bayesian optimization and reinforcement learning.

Aspect 7. The method of Aspect 4, wherein selecting the one or more of the neural network parameter values includes: searching the target distribution for the one or more of the neural network parameters based on a search cost function.

Aspect 8. The method of Aspect 4, wherein selecting the one or more of the neural network parameter values includes: searching the target distribution for the one or more of the neural network parameter values based on at least one of a safety metric associated with one or more searched neural network parameter values in the target distribution, a comfort metric associated with one or more searched neural network parameter values in the target distribution, and a performance metric associated with one or more searched neural network parameter values in the target distribution.

Aspect 9. The method of any of Aspects 1 to 9, further comprising: assigning a weight to each neural network parameter value in at least one of the exploration distribution and the target distribution based on a likelihood of usage of such neural network parameter value.

Aspect 10. The method of any of Aspects 1 to 10, wherein the neural network parameter includes at least one of a layer width, a kernel size, a number of layers, a depth of layers, a learning rate, and a number of layers in a block.

Aspect 11. A system comprising: a memory; and one or more processors coupled to the memory, the one or more processors being configured to: determine an exploration distribution of a neural network parameter for one or more neural networks of one or more autonomous vehicles (AVs), the exploration distribution of the neural network parameter comprising neural network parameter values; determine, for a target context, a target distribution of the neural network parameter from the exploration distribution, the target context comprising at least one of a driving environment associated with a location, a hardware configuration of one or more AVs, a software configuration of the one or more AVs, and a task of the one or more AVs; and provide, to a computer of an AV, the target distribution for implementing one or more of the neural network parameter values in the target distribution to adjust a neural network of the computer of the AV for operation in the target context.

Aspect 12. The system of Aspect 11, wherein the one or more processors are configured to: implement a subset of the neural network parameter values in the target distribution in the neural network of the AV in the target.

Aspect 13. The system of Aspect 11 or 12, wherein the neural network parameter values in the target distribution comprise a subset of the neural network parameter values in the exploration distribution.

Aspect 14. The system of any of Aspects 11 to 13, wherein the one or more processors are configured to: determine a context of the AV, the context comprising at least one of a driving environment associated with a location of the AV, a hardware configuration of the AV, a software configuration of the AV, and a task of the AV; and in response to determining that the context of the AV corresponds to the target context, select the one or more of the neural network parameter values in the target distribution for the target context to adjust the neural network of the computer of the AV.

Aspect 15. The system of Aspect 14, wherein the one or more processors are configured to: in response to determining that an amount of change in the context of the AV exceeds a threshold, update a neural network of a stack of the AV with the selected one or more of the neural network parameter values.

Aspect 16. The system of Aspect 14, wherein selecting the one or more of the neural network parameter values includes: searching the target distribution for determining the one or more of the neural network parameter values based on at least one of the target context and a search algorithm, the search algorithm comprising at least one of Bayesian optimization and reinforcement learning.

Aspect 17. The system of Aspect 14, wherein selecting the one or more of the neural network parameter values includes: searching the target distribution for the one or more of the neural network parameter values based on a search cost function.

Aspect 18. The system of any of Aspects 11 to 17, wherein the one or more processors are configured to: assign a weight to each neural network parameter value in at least one of the exploration distribution and the target distribution based on a likelihood of usage of such neural network parameter value.

Aspect 19. The system of any of Aspects 11 to 18, wherein the neural network parameter includes at least one of a layer width, a kernel size, a number of layers, a depth of layers, a learning rate, and a number of layers in a block.

Aspect 20. A non-transitory computer-readable medium having stored thereon instructions which, when executed by one or more processors, cause the one or more processors to perform a method according to any of Aspects 1 to 10.

Aspect 21. A system comprising means for performing operations in accordance with any one of Aspects 1 to 10.

Aspect 22. A computer-program product including instructions which, when executed by one or more processors, cause the one or more processors to perform a method according to any of Aspects 1 to 10.

What is claimed is:

1. A method comprising:
determining an exploration distribution of a neural network parameter for one or more neural networks of one or more autonomous vehicles (AVs), the exploration distribution of the neural network parameter comprising neural network parameter values;
determining, for a target context, a target distribution of the neural network parameter from the exploration distribution, the target context comprising at least one of a driving environment associated with a location, a hardware configuration of one or more AVs, a software configuration of the one or more AVs, and a task of the one or more AVs; and
providing, to a computer of an AV, the target distribution for implementing one or more of the neural network parameter values in the target distribution to adjust a neural network of the computer of the AV for operation in the target context.

2. The method of claim 1, further comprising:
implementing a subset of the neural network parameter values in the target distribution in the neural network of the AV in the target context.

3. The method of claim 1, wherein the neural network parameter values in the target distribution comprise a subset of the neural network parameter values in the exploration distribution.

4. The method of claim 1, further comprising:
determining a context of the AV, the context comprising at least one of a driving environment associated with a location of the AV, a hardware configuration of the AV, a software configuration of the AV, and a task of the AV; and
in response to determining that the context of the AV corresponds to the target context, selecting the one or more of the neural network parameter values in the target distribution for the target context to adjust the neural network of the computer of the AV.

5. The method of claim 4, further comprising:
in response to determining that an amount of change in the context of the AV exceeds a threshold, updating a neural network of a stack of the AV with the selected one or more of the neural network parameter values.

6. The method of claim 4, wherein selecting the one or more of the neural network parameter values includes:
searching the target distribution for determining the one or more of the neural network parameter values based on at least one of the target context and a search algorithm, the search algorithm comprising at least one of Bayesian optimization and reinforcement learning.

7. The method of claim 4, wherein selecting the one or more of the neural network parameter values includes:
searching the target distribution for the one or more of the neural network parameter values based on a search cost function.

8. The method of claim 4, wherein selecting the one or more of the neural network parameter values includes:
searching the target distribution for the one or more of the neural network parameter values based on at least one of a safety metric associated with one or more searched neural network parameter values in the target distribution, a comfort metric associated with one or more searched neural network parameter values in the target distribution, and a performance metric associated with one or more searched neural network parameter values in the target distribution.

9. The method of claim 1, further comprising:
assigning a weight to each neural network parameter value in at least one of the exploration distribution and the target distribution based on a likelihood of usage of such neural network parameter value.

10. The method of claim 1, wherein the neural network parameter includes at least one of a layer width, a kernel size, a number of layers, a depth of layers, a learning rate, and a number of layers in a block.

11. A system comprising:
a memory; and
one or more processors coupled to the memory, the one or more processors being configured to:
determine an exploration distribution of a neural network parameter for one or more neural networks of one or more autonomous vehicles (AVs), the exploration distribution of the neural network parameter comprising neural network parameter values;
determine, for a target context, a target distribution of the neural network parameter from the exploration distribution, the target context comprising at least one of a driving environment associated with a location, a hardware configuration of one or more AVs, a software configuration of the one or more AVs, and a task of the one or more AVs; and
provide, to a computer of an AV, the target distribution for implementing one or more of the neural network parameter values in the target distribution to adjust a neural network of the computer of the AV for operation in the target context.

12. The system of claim 11, wherein the one or more processors are configured to:
implement a subset of the neural network parameter values in the target distribution in the neural network of the AV in the target.

13. The system of claim 11, wherein the neural network parameter values in the target distribution comprise a subset of the neural network parameter values in the exploration distribution.

14. The system of claim 11, wherein the one or more processors are configured to:
determine a context of the AV, the context comprising at least one of a driving environment associated with a location of the AV, a hardware configuration of the AV, a software configuration of the AV, and a task of the AV; and
in response to determining that the context of the AV corresponds to the target context, select the one or more of the neural network parameter values in the target distribution for the target context to adjust the neural network of the computer of the AV.

15. The system of claim 14, wherein the one or more processors are configured to:
in response to determining that an amount of change in the context of the AV exceeds a threshold, update a neural network of a stack of the AV with the selected one or more of the neural network parameter values.

16. The system of claim 14, wherein selecting the one or more of the neural network parameter values includes:
searching the target distribution for determining the one or more of the neural network parameter values based on at least one of the target context and a search algorithm, the search algorithm comprising at least one of Bayesian optimization and reinforcement learning.

17. The system of claim 14, wherein selecting the one or more of the neural network parameter values includes:
searching the target distribution for the one or more of the neural network parameter values based on a search cost function.

18. The system of claim 11, wherein the one or more processors are configured to:
assign a weight to each neural network parameter value in at least one of the exploration distribution and the target distribution based on a likelihood of usage of such neural network parameter value.

19. The system of claim 11, wherein the neural network parameter includes at least one of a layer width, a kernel size, a number of layers, a depth of layers, a learning rate, and a number of layers in a block.

20. A non-transitory computer-readable medium having stored thereon instructions which, when executed by one or more processors, cause the one or more processors to:
determine an exploration distribution of a neural network parameter for one or more neural networks of one or more autonomous vehicles (AVs), the exploration distribution of the neural network parameter comprising neural network parameter values;
determine, for a target context, a target distribution of the neural network parameter from the exploration distribution, the target context comprising at least one of a driving environment associated with a location, a hardware configuration of one or more AVs, a software configuration of the one or more AVs, and a task of the one or more AVs; and
provide, to a computer of an AV, the target distribution for implementing one or more of the neural network parameter values in the target distribution to adjust a neural network of the computer of the AV for operation in the target context.
